(19) United States
(12) Patent Application Publication
(10) Pub. No.: US 2013/0008893 A1
(43) Pub. Date: Jan. 10, 2013

(54) ENERGY MANAGEMENT IN A MICROWAVE COOKING APPLIANCE

(75) Inventors: Derrick Douglas Little, Louisville, KY (US); Seth Hendrickson, Louisville, KY (US); Jonathan Bostock, Louisville, KY (US)

(73) Assignee: General Electric Company

(21) Appl. No.: 13/178,613

(22) Filed: Jul. 8, 2011

(51) Int. Cl. H05B 6/68

(52) U.S. Cl. 219/702

(57) ABSTRACT

A microwave oven comprises a cooking cavity and a RF generation module configured to deliver microwave energy into the cooking cavity. A controller receives and processes a signal indicative of the current state of an associated energy supplying utility for determining whether to operate the microwave oven in one of a normal operating mode and a power saving mode in response to the received signal. A power source is operatively associated with the controller and the RF generation module, and is configured to receive a signal from the controller and cause the microwave oven to operate in normal operating mode or in power saving operating mode in accord with the signal.

### CROSS REFERENCE TO RELATED APPLICATIONS

Cross-reference is made to commonly owned, copending application Ser. No. 12/559,705, filed 15 Sep. 2009 (Attorney Docket No. 238338 (GECZ 00997).

### BACKGROUND

This disclosure relates to energy management, and more particularly to energy management of household consumer appliances. The disclosure finds particular application to changing existing appliances via add-on features or modules, and incorporating new energy saving features and functions into new appliances.

Currently utilities charge a flat rate, but with increasing cost of fuel prices and high energy usage at certain parts of the day, utilities have to buy more energy to supply customers during peak demand. Consequently, utilities are charging higher rates during peak demand. If peak demand can be lowered, then a potential huge cost savings can be achieved and the peak load that the utility has to accommodate is lessened.

One proposed third party solution is to provide a system where a controller “switches” the actual energy supply to the appliance or control unit on and off. However, there is no active control beyond the mere on/off switching. It is believed that others in the industry cease some operations in an appliance during on-peak time.

There are also currently different methods used to determine when variable electricity-pricing schemes go into effect. There are phone lines, schedules, and wireless signals sent by the electrical company. One difficulty is that no peak shaving method for an appliance will provide a maximal benefit. Further, different electrical companies use different methods of communicating periods of high electrical demand to their consumers. Other electrical companies simply have rate schedules for different times of day.

Electrical utilities moving to an Advanced Metering Infrastructure (AMI) system will need to communicate to appliances, HVAC, water heaters, etc. in a home or office building. All electrical utility companies (more than 3,000 in the US) will not be using the same communication method to signal in the AMI system. Similarly, known systems do not communicate directly with the appliance using a variety of communication methods and protocols, nor is a modular and standard method created for communication devices to interface and to communicate operational modes to the main controller of the appliance. Although conventional WiFi/ZigBee/PLC communication solutions are becoming commonplace, this disclosure introduces numerous additional lower cost, reliable solutions to trigger “load shedding” responses in appliances or other users of power. This system may also utilize the commonplace solutions as parts of the communication protocols. Further, there is provided a mechanism for use with a cooking appliance, particularly a microwave, the mechanism functioning to shift the power level used by the microwave in accord with normal or energy saving operating modes depending on utility peak demand and off-peak demand period.

### BRIEF DESCRIPTION OF THE DISCLOSURE

According to one aspect, a microwave oven comprises a cooking cavity and an RF generation module configured to deliver microwave energy into the cooking cavity. A controller is operatively associated with the RF generation module. The controller receives and processes a signal indicative of the current state of an associated energy supplying utility for determining whether to operate the microwave oven in one of a normal operating mode and an energy saving mode. A power source is operatively associated with the controller and the RF generation module. The power source receives a signal from the controller and operates the microwave oven in normal operating mode or in energy saving operating mode in accord with the signal.

According to another aspect, a microwave oven control method is provided. The microwave oven communicates with an associated energy supplying utility. A state for the associated utility is determined. The utility state is indicative of at least a peak demand period or an off-peak demand period. The microwave oven is operated in a normal mode during the off-peak demand period or in an energy savings mode during the peak demand period by engaging an appropriate tap on a multi-tap transformer power source. The communication with the associated utility is blocked during operation of the microwave oven magnetron to prevent unreliable communications resulting from interference generated by the magnetron.

According to yet another aspect, a microwave oven comprises a cooking cavity and a RF generation module configured to deliver microwave energy into the cooking cavity. A controller is operatively associated with the RF generation module. The controller is configured to receive and process an energy signal from an associated utility. The signal has a first state indicative of a utility peak demand period and a second state indicative of a utility off-peak demand period. A power source is operatively associated with the controller and the RF generation module. The power source operates the microwave oven in one of an energy savings mode and a normal operating mode based on the signal received from the controller being in the first and second states, respectively. The power source is configured to reduce power of the RF generation module in the energy savings mode.

The present disclosure reduces peak power consumption during on-peak hours by reducing the peak energy consumed by a microwave oven. This is accomplished by utilizing a mechanism for reducing peak power consumption in a cooking appliance, such as a microwave oven, as well as to maintain the functionality and performance of the appliance while in the power saving mode. The power saving mode may be entered into in a number of ways, including but not limited to wireless, wired, voice-activated, push button, and any other common means of data transmitted protocols.

This disclosure provides a less time- and development-intensive alternative to adjusting the cooking algorithm used by current microwave ovens. The mechanism provided is a power source that allows either the utility or the consumer to shift between normal power usage during off-peak demand period and reduced power usage during peak demand period. For example, when the microwave is in energy saving mode and the power source is a multi-tap transformer, the transformer shifts to utilization of an appropriate tap on the transformer to supply a lower voltage to the magnetron which results in lower peak power consumption by the microwave oven without altering the duty cycle selected.

Still other features and benefits of the present disclosure will become apparent from reading and understanding the following detailed description.

### BRIEF DESCRIPTION OF THE DRAWINGS

FIGS. 1-8 illustrate exemplary embodiments of an energy management system for household appliances.

FIG. 9 is a schematic illustration of an exemplary demand managed microwave oven.

FIG. 10 is a schematic circuit diagram of a portion of the power circuit for the microwave oven of FIG. 9.

FIG. 11 is a graph of the power versus voltage characteristics of an exemplary magnetron power supply for a microwave oven.

FIG. 12 is an exemplary operational flow chart for the microwave oven of FIG. 9.

FIG. 13 is an exemplary control response for the microwave oven of FIG. 9.

### DETAILED DESCRIPTION OF THE PREFERRED EMBODIMENTS

In one embodiment, a mechanism is provided to achieve power savings in a cooking appliance, such as a microwave oven, as well as to maintain the functionality and performance of the appliance while in the power saving mode. The power saving mode may be entered into in a number of ways, including but not limited to wireless, wired, voice-activated, push button, and any other common means of data transmitted protocols. The foregoing provides a more advanced system to handle energy management between the utility and the homeowner's appliances. The mechanism provided utilizes a multi-tap transformer such that when a signal is received by the controller, the appropriate tap on the transformer is engaged and the power saving mode is initiated. When in power saving mode, the appliance operates with full functionality, but on a lower voltage output. Therefore, the time necessary to complete a cooking cycle may be slightly increased. The use of the multi-tap transformer foregoes the need to conduct complicated and time consuming cooking algorithm development aimed at compensating for existing software algorithms which do not provide for the energy saving mode.

In one embodiment, therefore, a microwave control system is provided that utilizes a multi-tap transformer to facilitate shifting between normal usage mode and power saving mode in order to more cost effectively operate the microwave by reducing the consumer's peak energy usage, while at the same time allowing the utility to more efficiently utilize its power supply. In the alternative, the microwave control system may utilize other mechanisms to enhance the energy saving potential of the microwave. For example, though an inverter is a relatively costly alternative for a transformer, this type of mechanism might also be employed to provide the capability to switch between normal and power savings modes. Another potential relatively costly alternative is a DC power supply. Yet another option to facilitate switching between normal and power saving modes would be the use of multiple transformers, which, not unlike the inverter and DC options, is likely relatively costly. Even so, it is contemplated herein that the microwave control system provided may include any one of these options, or any other option, so long is it provides a means to efficiently shift the power consumption of the appliance between normal and power saving mode(s). As such, though the following disclosure is presented with reference to the use of a multi-tap transformer, one skilled in the relevant field of technology will understand that any of the foregoing options may be utilized in accord herewith.

With regard to the microwave control system provided herein, in one embodiment, the system utilizes a multi-tap transformer. The output voltage produced by a secondary winding when the tap is engaged is less than that produced when the appliance is operated in normal usage mode. In the power savings mode, the system operates on a reduced instantaneous power, allowing the utility to operate their facility at a higher level of efficiency. This provides the utility with a better opportunity to optimize the energy distribution methods used in providing power to their customers.

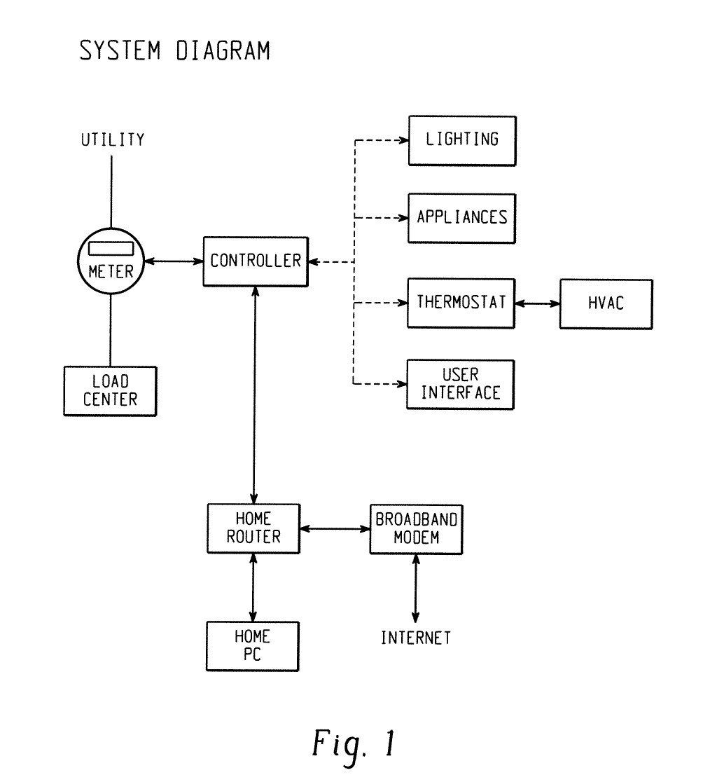

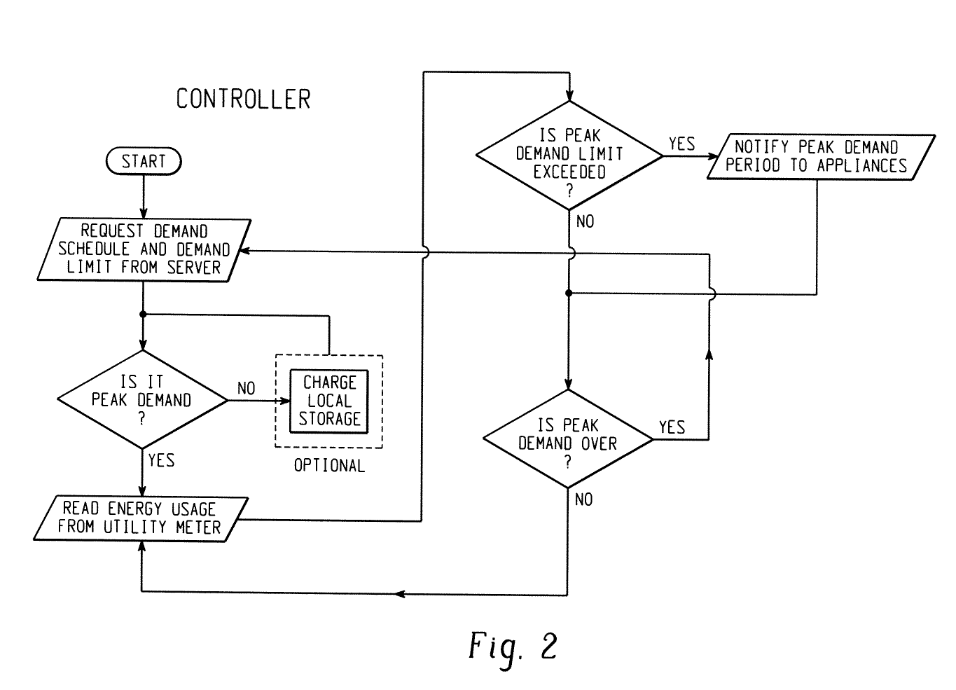

Information may be communicated to the microwave in accord with any system in place to manage energy consumption, and may include consumer driven application or one or more of the following: a controller, utility meter, communication network, intelligent appliances, local storage, local generator and/or demand server. Less advanced systems may actually allow the appliance to “communicate directly with the utility meter or mesh network through the DSMM (Demand Side Management Module) (FIG. 1). The demand server is a computer system that notifies the controller when the utility is in peak demand and what is the utility's current demand limit. A utility meter can also provide the controller the occurrence of peak demand and demand limit. As noted above, the demand limit can also be set by the home owner. Additionally, the homeowner can choose to force various modes in the appliance control based on the rate the utility is charging at different times of the day. The controller will look at the energy consumption currently used by the home via the utility meter and see if the home is exceeding the demand limit read from the server. If the demand limit is exceeded, the controller will notify the intelligent microwave appliance and force use of the energy saving mode tap on the multi-tap transformer (FIG. 2).

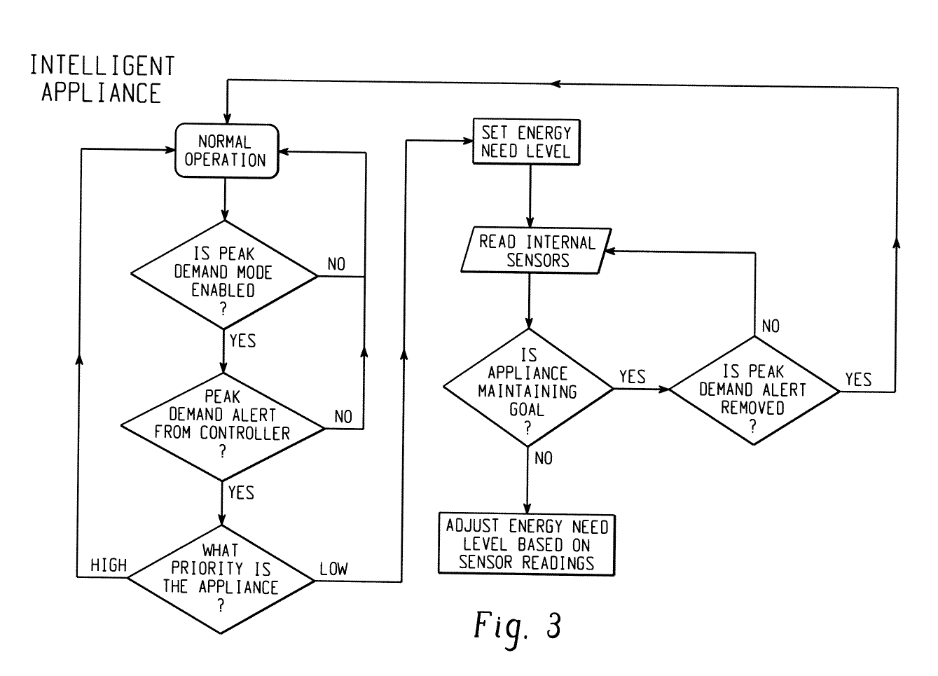

The intelligent appliance has a communication interface that links itself to the controller (FIG. 3). This interface can be power-line carrier, wireless, and/or wired. The controller will interact with the appliance and heat/time selection controls to execute the user's preferences/settings.

Enabled appliances receive signals from the utility meter and help lower the peak load on the utility and lower the amount of energy that the consumer uses during high energy cost periods of the day. There are several ways to accomplish this, through wireless communication (ZigBee, WiFi, etc) or through PLC (power line carrier) communication. Alternatively, using passive RFID tags that resonate at different frequencies resonated by the master, or one or more active RFID tags that can store data that can be manipulated by the master device and read by the slave device(s), is an effective and potentially lower cost communication solution since there is no protocol. Rather, a pulse of energy at a particular frequency will allow a low cost method with an open protocol for transmitting/communicating between a master device and one or more slave devices, and appropriate functions/actions can be taken based upon these signals.

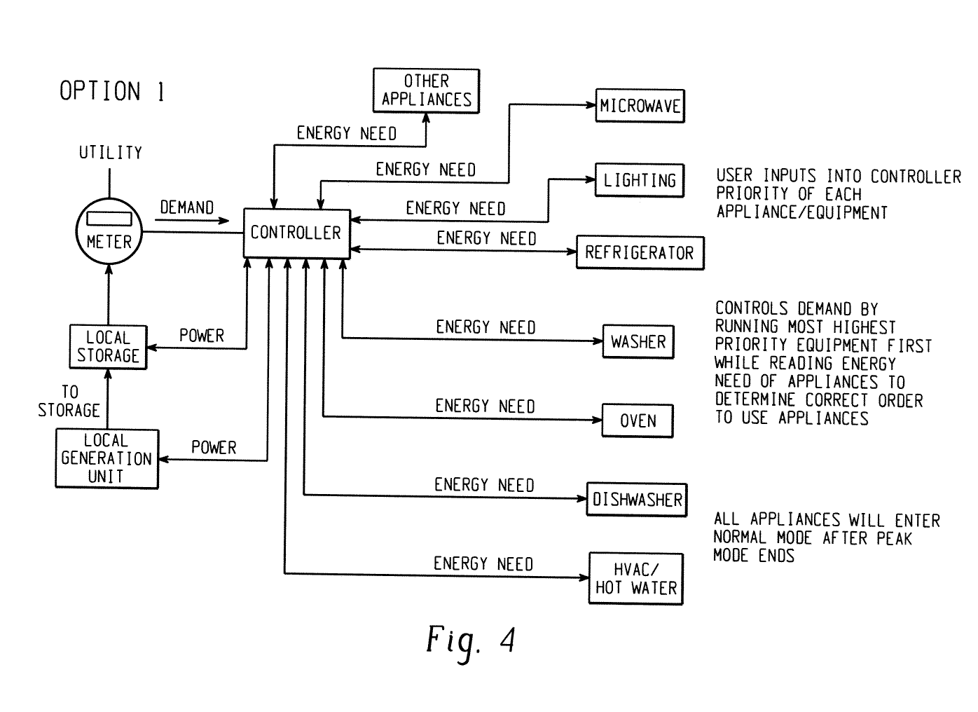

The interaction between controller and appliances can occur in two ways. For example, in one scenario, during a peak demand period the controller will receive a demand limit from the utility, demand server or user. The controller will then allocate the home's demand based on two factors: priority of the appliance and energy need level (FIG. 4). The priority dictates which appliances have higher priority to be in full or partial energy mode than other appliances. Energy need dictates how much energy is required for a certain time period in order for that appliance to function properly. If the appliance's energy need is too low to function properly, the appliance moves to a normal mode or a higher energy need level. The energy saving mode is typically a lower energy usage mode for the microwave and may involve reduced power supply necessitating longer operating times. Once the demand limit is reached, the appliance, in this scenario a microwave, will stay in its energy saving mode until peak demand is over, or a user overrides, or the appliance finishes the need cycle or the priority changes. The controller constantly receives status updates from the appliances in order to determine which state they are in and in order to determine if priorities need to change to accomplish the system goals.

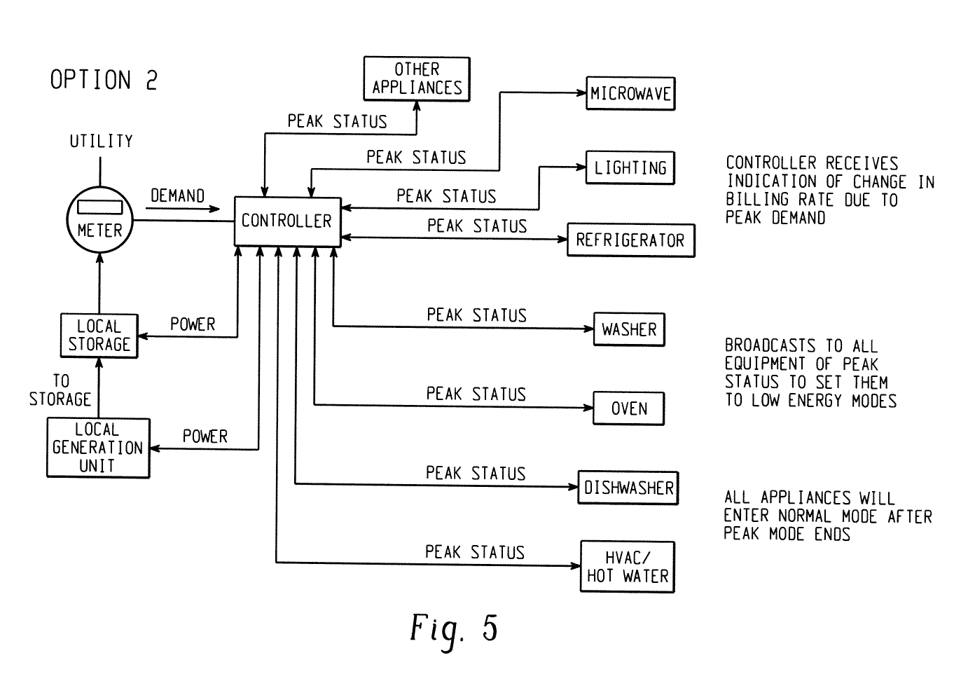

In a second scenario, for example, a set point is provided. During a peak demand period, the controller will tell each appliance to go into an energy savings mode (FIG. 5). The appliance will then go into a lower energy mode. The customer can deactivate the energy savings mode by selecting a feature on the appliance front end controls (i.e. user interface board) before or during the appliance use or at the controller.

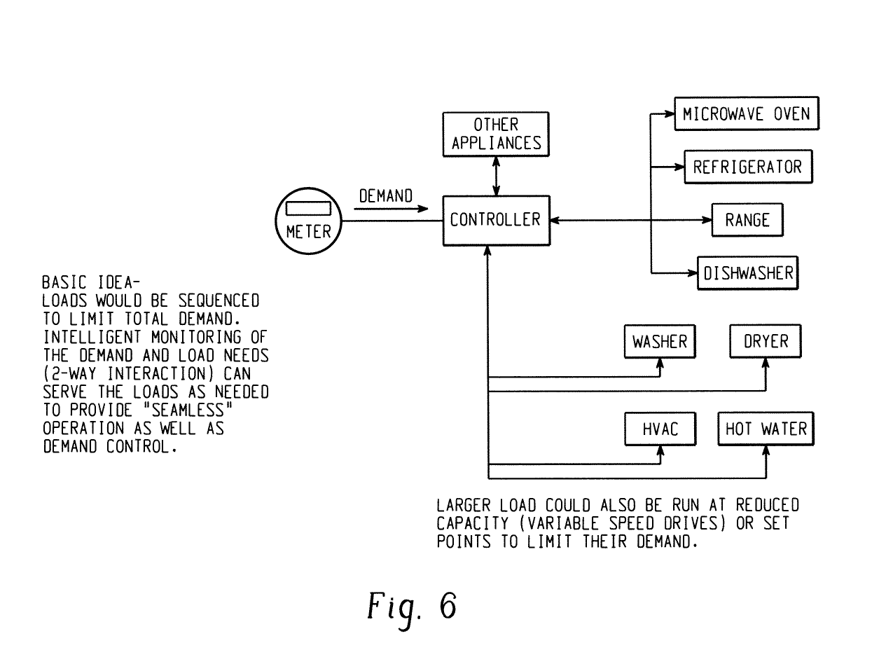

The central controller handles energy management between the utility and home appliances, lighting, thermostat/HVAC, etc. with customer choices incorporated in the decision making process. The controller may include notification of an energy saving mode based on demand limit read from one or more of a utility meter, utility, demand server or user. An energy savings mode of an appliance can thereby be controlled or regulated based on priority and energy need level sent from the controller and/or the customer (FIG. 6).

How much energy the appliance consumes in peak demand is based on priority of the device and the energy need level. If the appliance's priority is high, then the appliance will most likely not go into an energy saving mode. The energy need level is based on how little energy the appliance can consume during peak demand and still provide the function setting it is in. It will also be appreciated that an appliance may have multiple energy need levels.

A controller has a port for receiving information regarding the operational state of the appliance. The port also has a user interface or switch which could be used to override the information received by the controller through the port. Two-way or one-way communication devices may be connected to the port. These communication devices will receive signals from a remote controller, process those signals and as a result communicate an operational state to the main controller of the appliance. This operational state is communicated to the main controller by one or more remote controllers in a specific format determined by the appliance. These signals from the remote controller(s) could be based on a variety of communication methods and associated protocols. On receiving the operational state signal, the appliance main controller causes the appliance to run a predetermined operational mode. These operational modes are designed into the appliance(s) and result in different resource consumption levels or patterns. Resources for microwave cooking appliances could include energy, heat, time, etc. In future appliance models, the consumer might be given the authority to modify the appliance responses to a given rate signal. The consumer would be presented a “check box” of potential response modes and be allowed to choose within set parameters. For instance, the consumer might be allowed to choose the amount of power level reduction a microwave will make in response to a high utility rate.

A method of communicating data between a master device and one or more slave devices may advantageously use a continuous tone-coded transmission system. This can be a number of states or signals, using one or more continuous tones that signify different rate states coming from the home area network (from meter) or the utility. Additionally, one could send a combination of tones to transmit binary messages using a few tones. The slave devices will incorporate a receiver that receives the carrier frequency and then decodes the continuous tone which corresponds to the particular state of the utility rate. Once the “receiver board” detects the tone, then the downstream circuitry will trigger the appropriate response in the appliance. The carrier frequency in this scheme can be numerous spectrums, one being the FM broadcast band or a specific FM band allocated by the FCC for low level power output. The advantage of broadcast band FM is the low cost of such devices and the potential to penetrate walls, etc. within a home with very low levels of power due to the long wavelength of the 89-106 Mhz carrier. This process is used today in 2-way radio communications to reduce the annoyance of listening to multiple users on shared 2-way radio frequencies. The process in these radios is referred to as CTCSS (continuous tone-coded squelch system) and would find application in this end use.

Generally, it is not known to have modular interfaces that can receive signals from a control source. Also, no prior arrangements have functioned by addressing the control board of the appliance with a signal that directs the appliance to respond.

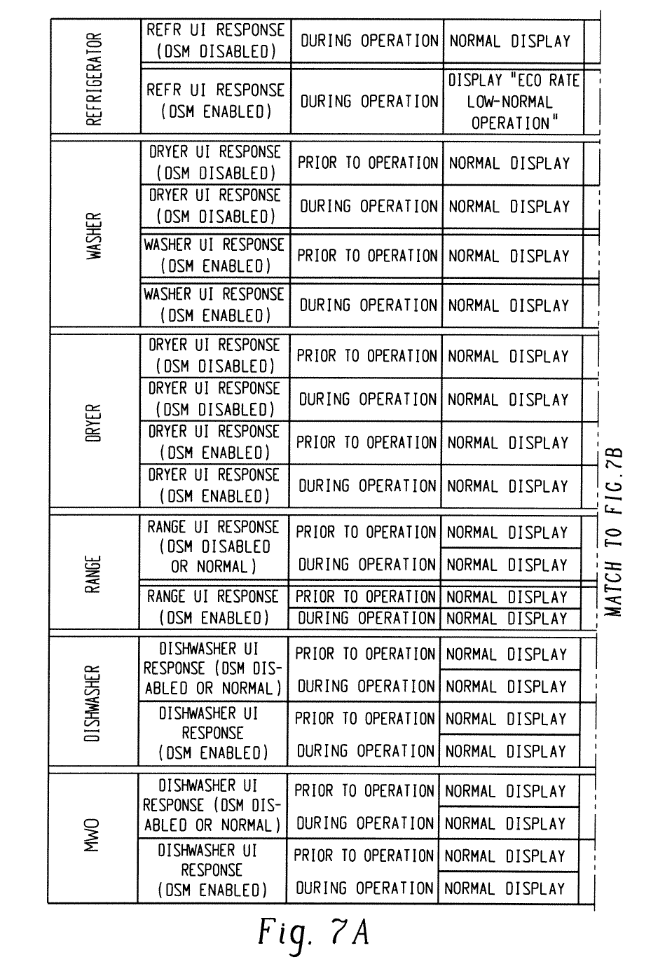

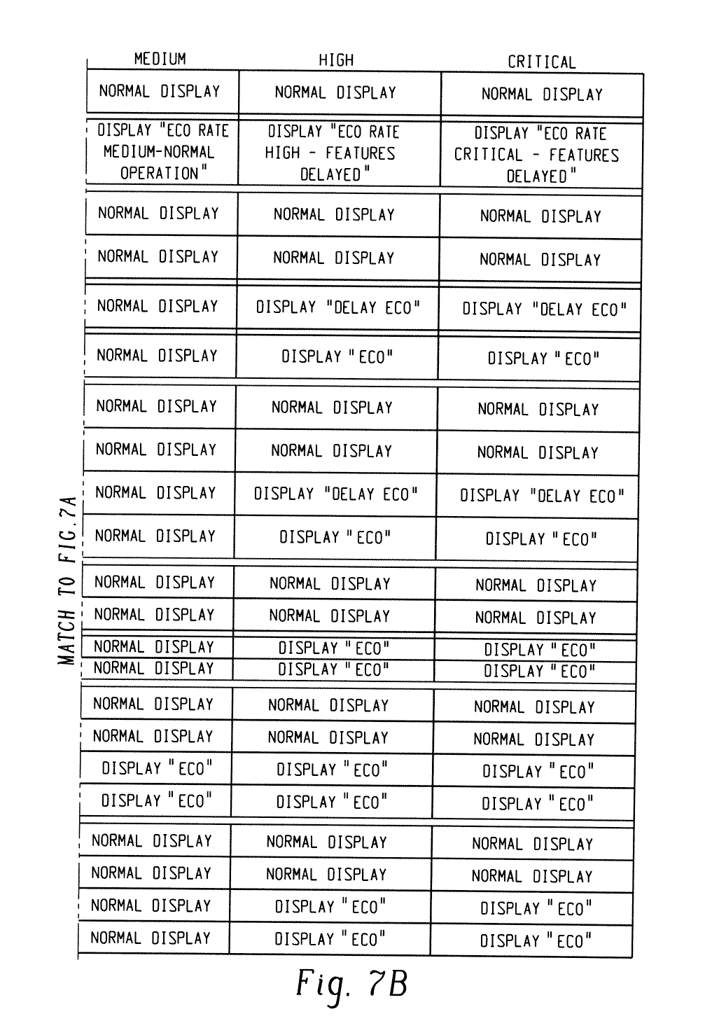

Thus, by way of example only, the structure and/or operation of an appliance, in this instance a microwave oven (FIGS. 7A and 7B, although other appliances are also represented), may be modified or altered by reducing the power level at which the microwave oven operates by at least about 10%, and preferably by at least about 20%.

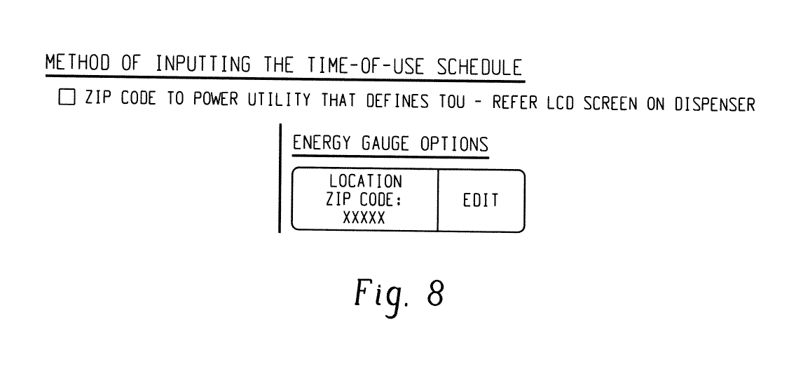

The consumer may be given the ability to select via a user interface which items are incorporated into the on-peak demand via an enable/disable menu, or to provide input selection such as entry of a zip code (FIG. 8) in order to select the utility company and time of use schedule, or using a time versus day of the week schedule input method.

The above description relates to appliances in general, and finds application for refrigerators, dishwashers, water heaters, washing machines, clothes dryers, microwaves, televisions (activate a recording feature rather than turning on the television), etc., which list is simply representative and not intended to be all encompassing.

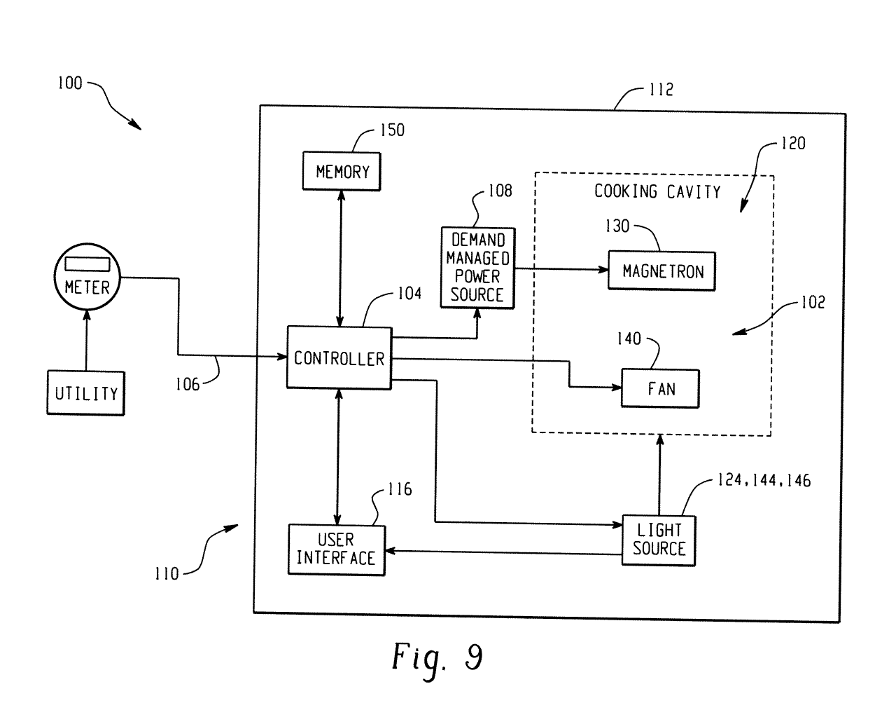

An exemplary embodiment of a demand managed microwave oven cooking appliance 100 is schematically illustrated in FIG. 9. The appliance 100 comprises at least one power consuming feature/function 102 and a controller 104 operatively associated with the power consuming feature/function. The controller 104 can include a micro computer on a printed circuit board which is programmed to selectively control the energization of the power consuming feature/function. The controller 104 is configured to receive and process a signal 106 indicative of a utility state, for example, availability and/or current cost of supplied energy. The energy signal may be generated by a utility provider, such as a power company, and can be transmitted via a power line, as a radio frequency signal, or by any other means for transmitting a signal when the utility provider desires to reduce demand for its resources. The cost can be indicative of the state of the demand for the utility's energy, for example a relatively high price or cost of supplied energy is typically associated with a peak demand state or period and a relative low price or cost is typically associated with an off-peak demand state or period.

The controller 104 can operate the appliance 100 in one of a plurality of operating modes, including a normal operating mode and an energy savings mode, in response to the received signal. Specifically, the appliance 100 can be operated in the normal mode in response to a signal indicating an off-peak demand state or period and can be operated in an energy savings mode in response to a signal indicating a peak demand state or period. As will be discussed in greater detail below, the controller 104 is configured to at least one of selectively delay, adjust and disable at least one of the one or more power consuming features/functions to reduce power consumption of the appliance 100 in the energy savings mode.

As shown in FIG. 9, the appliance 100 is a microwave oven 110 generally including an outer case 112 and a control panel or user interface 116. The microwave oven further includes a door (not shown) mounted within a door frame (not shown), a grille (not shown) and a window (not shown) located in the door for viewing food in an oven cooking cavity 120. The control panel 116 can include a display and control buttons for making various operational selections. Cooking algorithms can be preprogrammed in the oven memory 150 for many different types of foods. When a user is cooking a particular food item for which there is a preprogrammed cooking algorithm, the preprogrammed cooking algorithm is selected by pressing one of the control buttons. Instructions and selections are displayed on the display. A light source 124 is provided for illuminating the user interface 116.

To heat the food placed within the cooking cavity 120, the microwave oven includes an RF generation module or magnetron 130 which is typically located on a side or top of the cooking cavity 120. The magnetron can be mounted to a magnetron mount on a surface of the cooking cavity. The RF generation module 130 is configured to deliver microwave energy into the cooking cavity 120. The microwave oven further includes a fan 140 for cooling the magnetron and a light source 144 for illuminating the cooking cavity 120. For an over the range type microwave oven, a separate light source 146 can be provided for illuminating a top cooking surface of a range. The microwave oven 110 is provided by way of illustration rather than limitation, and accordingly there is no intention to limit application of the present disclosure to any particular microwave oven.

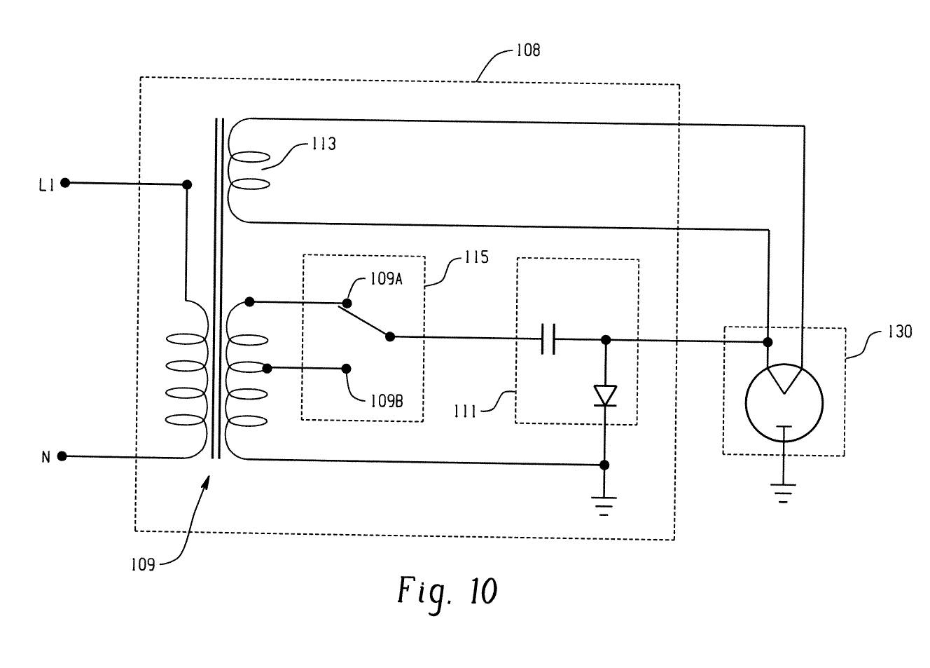

Power to the magnetron 130 is supplied from demand managed power source 108. In one embodiment, as best seen in FIG. 10, a microwave control system is provided that utilizes a multi-tap high voltage transformer 109 to facilitate shifting between normal usage mode and power saving mode in order to more cost effectively operate the microwave by reducing the consumers energy usage, while at the same time allowing the utility to more efficiently utilize its power supply. In the embodiment of FIG. 10, the power source 108 is essentially a conventional voltage doubling circuit, comprising high voltage transformer 109 having a primary winding coupled to the household AC power supply L1, N, and a main secondary winding coupled to the input of the magnetron 130 via a high voltage capacitor/diode circuit 111, the difference being that main secondary winding comprises two taps, 109A and 109B. A second secondary winding 113 of transformer 109 is coupled in conventional manner to magnetron filament heaters. Tap 109A provides the full output voltage of the main secondary winding for operation in the normal operating mode. Tap 109B provides the lower voltage for operation in the energy saving mode. Taps 109A and 109B are selectively connected to the magnetron input by switch 115 the state of which is controlled by controller 104 (FIG. 9). In the illustrative embodiment, switch 115 is a relay, however, any suitable selectively switchable device could be similarly employed. By this arrangement, for operation in the normal mode the controller closes switch 115 across tap 109A and for operation in the energy savings mode, the controller closes switch 115 across tap 109B. In the alternative, as mentioned above, the microwave control system may utilize other mechanisms as an alternative to the multi-tap transformer, including but not limited to separate transformers or an inverter circuit.

In the normal operating mode, a user places food on a turntable located in the cooking cavity 120. The user then selects a preprogrammed cooking algorithm, a cooking time and/or a power level and then selects “Start” from the control panel 116. The magnetron 130 is then energized from power source 108 in accordance with the user selections. The fan 140 is provided to cool the magnetron. The controller 104 and demand managed power source 108 are configured to cyclically energize and de-energize the magnetron 130 during the selected cooking period. The duty cycle for the magnetron 130, that is the percent on time for the magnetron during the control time period, can depend on at least one of a pre-programmed cooking algorithm and a user selected operation mode. More specifically, in an exemplary embodiment, the controller 104 can operate the magnetron on a 32 second control time period. Different foods will cook best with different duty cycles. The microwave oven 110 allows control of these power levels through both pre-programmed cooking algorithms and through user-customizable manual cooking. Microwave energy from the magnetron 130 heats the food. The magnetron can be energized for a 100% duty cycle, that is, the magnetron is energized for 100% of the control period, or can cycle on and off at a lower duty cycle based on the selected power level during each control period. For example if the selected power level calls for an 80% duty cycle, the magnetron would be energized for 25.6 seconds of each 32 second control period and off for the remaining 6.4 seconds.

In order to reduce the peak energy consumed by the microwave oven 110, the controller 104 is configured to selectively adjust and/or disable at least one of the one or more above described power consuming features/functions to reduce power consumption of the microwave oven 110 in the energy savings mode. Reducing total energy consumed also encompasses reducing the energy consumed at peak times and/or reducing the overall electricity demands. To this extent, the controller 104 is configured to reduce a power level of the magnetron 130 in the energy savings mode. For example, in response to a load shedding signal, the controller 104 can switch from a high voltage tap point (tap 109A) on the transformer to a low voltage tap point (tap 1098). The controller 104 is also configured to reduce speed of the fan 140 and reduce the intensity of at least one of the light sources 124, 144, 146 in the energy savings mode. Since energization of the magnetron is the primary energy consuming feature of the microwave oven, changes to the operation of the magnetron have the most significant impact for reducing peak energy. The following illustrates the relationship of the peak/off-peak energy usage, to cook food to a desired temperature, T₂, from a starting temperature T_{L} The energy equation is:

(Power)(time)=(m)(C)(T₂−T₁).

This equation takes into consideration that the right hand side of the equation is always the same:

(P₁)(t₁)=(m)(C)(T₂−T₁), and

(P₂)(t₂)=(m)(C)(T₂−T₁).

Therefore:

(P₁)(t₁)=(P₂)(t₂)

where:

P₁ designates normal mode input power;

t₁ designates normal mode cook time;

P₂ designates energy saving mode input power; and

t₂ designates energy saving mode cook time.

Consequently, the reduction in power when operating in the energy saving mode increases the duration of the cooking period as follows:

(t₂)=(P₁/P₂)(t₁)

The duty cycle, or ratio of the on time, can be precisely controlled and is pre-determined by the operating parameters selected by the user.

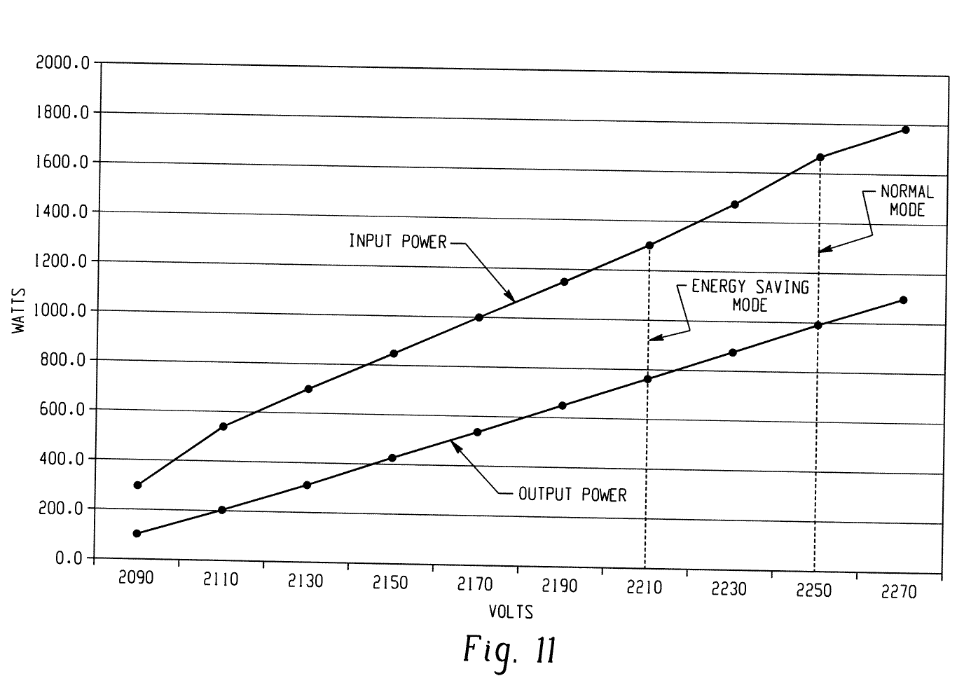

FIG. 11 shows the input and output power of the magnetron 130 as a function of the voltage applied to the input of voltage doubler circuit 111. If for example, tap 109A of transformer 109 (FIG. 10) is arranged to provide an output voltage of 2250 volts, the power drawn by the magnetron circuit would be approximately 1700 watts and the output power of the magnetron would be approximately 1000 watts. By arranging tap 109E to provide an output voltage of 2210 volts, the power drawn by the magnetron circuit when connected to tap 109B would be approximately 1300 watts and the output power of the magnetron would be approximately 800 watts. By this arrangement, the power consumption of the magnetron when operating in the energy saving mode is reduced to approximately 80% relative to the normal operating mode. The power could be reduced to less than 80% by appropriate arrangement of tap 109B. Similarly the reduction in power could be to a level greater than 80%. Also, more than one tap could be provided to permit operation at additional lower levels.

In some instances, the quality of the incoming energy signal 106 from the utility can be impacted or degraded by interference from the fundamental frequency of the magnetron 130. A typical microwave oven uses between 500 and 1000 W of microwave energy at 2.45 GHz to heat the food. There may be a high likelihood that the frequency bands of microwave signals generated by the magnetron create interference with frequency bands used for Wibro communication, HSDPA (High Speed Downlink Packet Access), wireless LAN (Local Area Network. IEEE 802.22 standards), Zigbee (IEEE802.15 standards), Bluetooth (IEEE802.15 standards) and RFID (Radio Frequency Identification). Consequently, whenever the microwave oven 110 is generating interference via the activated magnetron 130, the controller 104 may have problems receiving and processing the energy signal 106. Generally, the only time the controller 104 can satisfactorily receive and process the energy signal 106 is when there is no interference. For example, if the microwave oven is operating at a 60% duty cycle, interference is present for the 60% of the time that the magnetron 130 is activated, and the controller 104 can reliably receive and process the energy signal 106 only 40% of the time. To avoid problems that might result from such degradation, the controller 104 is configured to temporarily block communication during activation of the magnetron 130 Given the periodic nature of microwave oven interference, the controller 104 can be configured to predict the windows in time for which the interference will and will not be present while the magnetron 130 is active. For the 60% duty cycle example, during the approximately 18 seconds of the 32 second control period that the magnetron is energized, communication is blocked by the controller. During the approximately 14 seconds of off time, communication is enabled. During the on portion of the control period, the energy signal can be queued in a memory 150. After deactivation of the magnetron 130, the controller 104 can review and process the queued energy signal stored in the memory 150 to at least partially determine the operating mode for the microwave oven 110, or simply respond to the then current signal from the utility. If the microwave oven 110 is to operate in the energy savings mode, the power lever of the magnetron 130 can be selectively adjusted to reduce the power consumed by the magnetron during subsequent operation. Alternatively, rather than block communication whenever the magnetron is energized, the controller may be configured to determine whether the frequency of the energy signal 106 can be generally harmonic with and/or at least partially degraded by the frequency of the activated magnetron 130, and selectively block communication accordingly to avoid communication such degradation issues.

For example, according to one exemplary embodiment, the magnetron 130 of the RF generation module operates on a duty cycle throughout a selected cooking period. The magnetron cycles on and off during the duty cycle. The controller 104 is configured to block signal communication when the RF generation module 130 is on. Alternatively, the controller 104 is configured to block the signal communication during the entire duty cycle of the RF generation module. The microwave oven 110 continues operation in that one of the normal operating mode and the energy savings mode that it was in when the signal is blocked, during a time period that the signal is blocked. Particularly, the microwave oven temporarily stops communication with the energy signal and continues to operate in its current operating mode during the time period that the signal is blocked. As set forth above, the controller 104 is configured to queue the blocked signal during operation of the magnetron 130. The queue is processed after operation of the microwave oven 110 for at least partially determining current operating mode for the microwave oven.

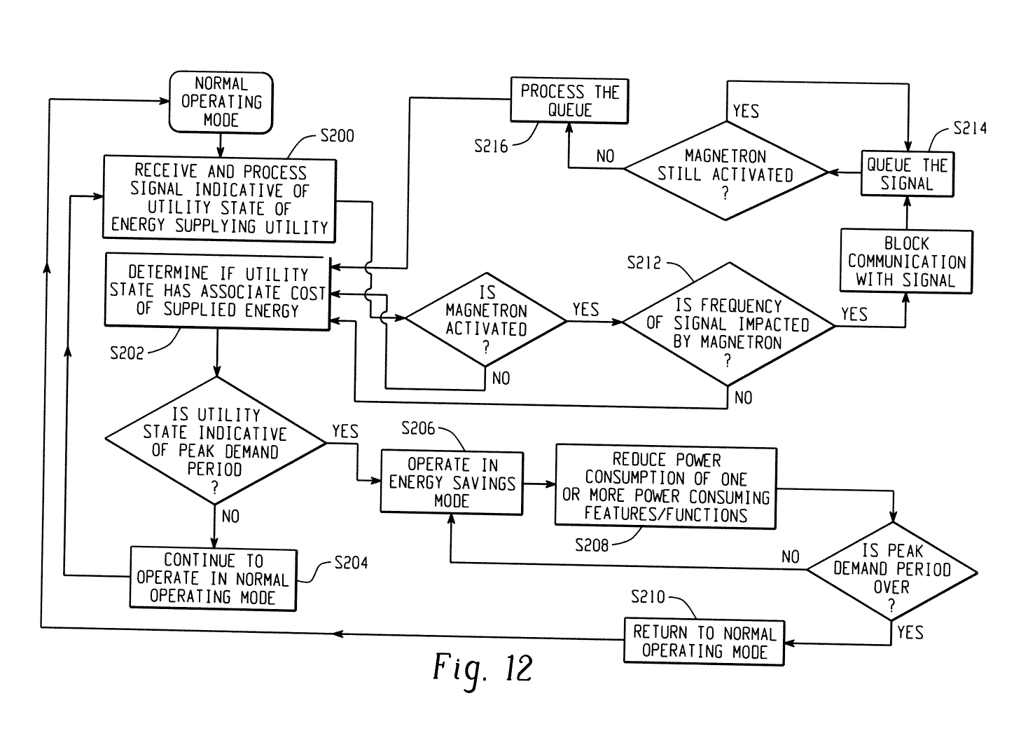

With reference to FIG. 12, a control method in accordance with the present disclosure comprises communicating with an associated utility and receiving and processing the signal indicative of cost of supplied energy (S200), determining a state for an associated energy supplying utility, such as a cost of supplying energy from the associated utility (S202), the utility state being indicative of at least a peak demand period or an off-peak demand period, operating the microwave oven 110 in a normal mode during the off-peak demand period (S204), operating the microwave oven 110 in an energy savings mode during the peak demand period (S206), selectively adjusting any number of one or more power consuming features/functions of the microwave oven to reduce power consumption of the appliance in the energy savings mode (S208), and returning to the normal mode after the peak demand period is over (S210). The selective adjustment can include reducing power to the magnetron 130 in the energy savings mode, reducing speed of the fan 140 in the energy savings mode, and reducing an intensity of at least one of the light sources 124, 144, 146 in the energy savings mode. For example, power can be reduced in energy saving mode (S208) by engaging an appropriate tap on a multi-tap transformer. In the alternative, another suitable power source, such as an inverter, a DC source, or multiple transformers, may be utilized to provide the capability to shift energy usage between normal and one or more power saving modes.

The control method further includes temporarily blocking the communication with the associated utility during operating of the microwave oven to prevent unreliable communications during operation of the microwave oven (S212), queuing the communication with the associated utility during operating of the microwave oven (S214), and processing the queue after operation of the microwave oven for at least partially determining current operating mode for the microwave oven (S216).

It is to be appreciated that a selectable override option can be provided on the user interface 116 providing a user the ability to select which of the one or more power consuming features/functions are adjusted by the controller in the energy savings mode. The user can override any adjustments, whether time related or function related, to any of the power consuming functions. The operational adjustments, particularly an energy savings operation, can be accompanied by a display on the panel which communicates activation of the energy savings mode. The energy savings mode display can include a display of “ECO”, “Eco”, “EP”, “ER”, “CP”, “CPP”, “DR”, or “PP” on the appliance display panel in cases where the display is limited to three characters. In cases with displays having additional characters available, messaging can be enhanced accordingly. Additionally, an audible signal can be provided to alert the user of the appliance operating in the energy savings mode.

The duration of time that the appliance 100 operates in the energy savings mode may be determined by information in the energy signal. For example, the energy signal may inform the appliance 100 to operate in the energy savings mode for a few minutes or for one hour, at which time the appliance returns to normal operation. Alternatively, the energy signal may be continuously transmitted by the utility provider, or other signal generating system, as long as it is determined that instantaneous load reduction is necessary. Once transmission of the signal has ceased, the appliance 100 returns to normal operating mode. In yet another embodiment, an energy signal may be transmitted to the appliance to signal the appliance to operate in the energy savings mode. A normal operation signal may then be later transmitted to the appliance to signal the appliance to return to the normal operating mode.

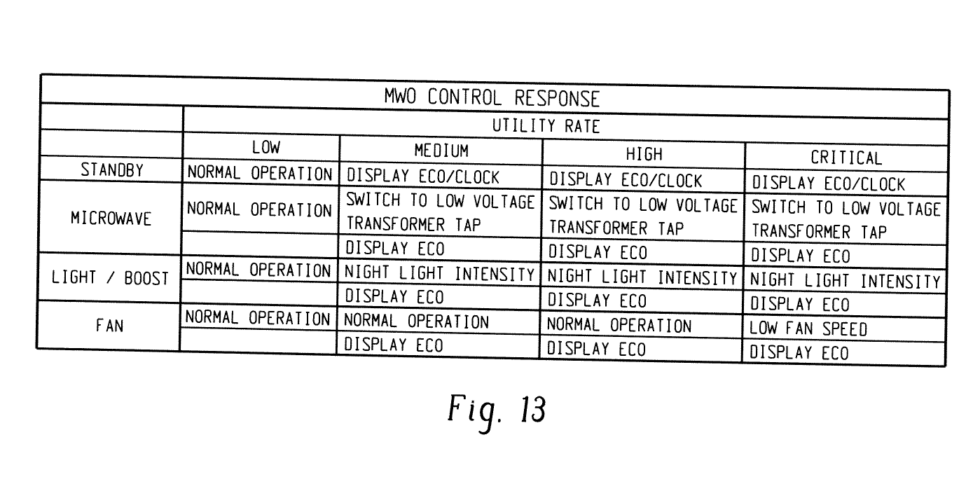

The operation of the appliance 100 may vary as a function of a characteristic of the supplied energy, e.g., availability and/or price. Because some energy suppliers offer what is known as time-of-day pricing in their tariffs, price points could be tied directly to the tariff structure for the energy supplier. If real time pricing is offered by the energy supplier serving the site, this variance could be utilized to generate savings and reduce chain demand. Another load management program offered by energy suppliers utilizes price tiers which the utility manages dynamically to reflect the total cost of energy delivery to its customers. These tiers provide the customer a relative indicator of the price of energy and are usually defined as being LOW, MEDIUM, HIGH and CRITICAL. These tiers are shown in the chart of FIG. 13 to partially illustrate operation of the microwave oven 110 in each pricing tier. For example, with such a tiered system from the energy supplier, when a user activates any feature on the appliance 100, the controller 104 polls the ports for the incoming energy signal 106. Based on the energy signal, the appliance will perform in one of the four pricing tiers. In the event the user has selected a feature that requires the magnetron 130 during any tier other than LOW, the controller 104 can change the level of voltage applied to the magnetron via a transformer tap. The duty cycling associated with the feature selected can remain the same and the power of the magnetron 130 is adjusted. However, it will be appreciated that the controller could be configured to implement a unique operating mode for each tier which provides a desired balance between compromised performance and cost savings/energy savings. If the utility offers more than two rate/cost conditions, different combinations of energy saving control steps may be programmed to provide satisfactory cost savings/performance tradeoff.

The transformer may be any multi-tap transformer known for use with microwave cooking appliances. Generally, the use of a multi-tap transformer in conjunction with the controller provides a mechanism for providing cooking power, and for maintaining functionality and performance of the appliance while in the power saving mode. The mode of operation may be entered by the utility through the controller, wirelessly, hard-wired, etc., and by the consumer through wireless, hard-wired, voice-activated, push button, or any other known means to transmit data protocols. Once the signal is received, the transformer engages the appropriate tap of the multi-tap transformer corresponding with the incoming signal. When the power savings mode is engaged, the secondary winding produces a lower output voltage than when in normal mode.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A microwave oven comprising:
a cooking cavity;
a RF generation module configured to deliver microwave energy into the cooking cavity;
a controller for receiving and processing a signal indicative of a current state of an associated energy supplying utility for determining whether to operate the microwave oven in one of a normal operating mode and an energy saving mode; and
a power source operatively associated with the controller and the RF generation module, the power source configured to receive a signal from the controller and transmit the signal to the RF generation module to operate the microwave oven in normal operating mode or in energy saving operating mode in accord with the signal received from the controller.

2. The microwave oven of claim 1, wherein the power source is selected from an inverter, a DC power source, multiple transformers, or a multi-tap transformer, configured to maintain a power level of the RF generation module in the normal energy mode and to reduce a power level of the RF generation module in the power saving mode.

3. The microwave oven of claim 2, wherein the power source is a multi-tap transformer.

4. The microwave oven of claim 3, wherein the multi-tap transformer includes at least one of:
(i) a tap configured to maintain a power level of the RF generation module in the normal operating mode when the tap is engaged; and
(ii) a tap configured to reduce a power level of the RF generation module in the power saving mode when the tap is engaged.

5. The microwave oven of claim 3, wherein the multi-tap transformer has at least three taps configured to operate the microwave oven in varying degrees of power supply between and including normal operating mode and complete power saving operating mode.

6. The microwave oven of claim 4, wherein the power supply is a multi-tap transformer that engages to operate the RF generation module at full power in a normal mode and at approximately 80% power in a power saving mode.

7. The microwave oven of claim 1, wherein the power saving mode is entered into using a data transmitting protocol that is selected from wireless, wired, voice-activated, push button, or any combination thereof.

8. The microwave oven of claim 1, wherein the controller is configured to selectively adjust and/or deactivate one or more power consuming features/functions of the microwave oven to reduce power consumption in the power saving mode.

9. The microwave oven of claim 8, further comprising a user interface operatively connected to the controller, the user interface including a selectable override option to enable a user to prevent the controller from selectively adjusting and/or deactivating the one or more power consuming features/functions in the energy saving mode.

10. The microwave oven of claim 9, wherein the user interface further includes a display communicating activation of the power saving mode.

11. The microwave oven of claim 10, wherein the power saving mode display includes a display selected from the group consisting of ‘“ECO”, “Eco”, “EP”, “ER”, “CP”, “CPP”, “DR”, and “PP”.

12. A microwave oven control method, comprising:
communicating with an associated utility;
determining a state for an associated energy supplying utility, the utility state being indicative of at least a peak demand period or an off-peak demand period;
operating the microwave oven by delivering power to the microwave oven from an RF generation module in a normal mode during the off-peak demand period or in an energy saving mode during the peak demand period; and
blocking the communication with the associated utility when the energy generation module is energized to prevent unreliable communications during operation of the microwave oven.

13. The method of claim 12, wherein the RF generation module operates on a duty cycle throughout a selected cooking cycle, the RF generation module cycling on and off during the duty cycle and wherein the blocking step comprises blocking communication when the RF generation module is cycled on and enabling communication when the RF generation module is cycled off.

14. The method of claim 12, further comprising:
queuing the communication with the associated utility when the energy generation module is energized, and
processing the queue after when the energy generation module is not energized for at least partially determining current operating mode for the microwave oven.

15. A microwave oven comprising:
a cooking cavity;
a RF generation module configured to deliver microwave energy into the cooking cavity;
a controller for receiving and processing a signal indicative of current state of an associated energy supplying utility for determining whether to operate the microwave oven in one of a normal operating mode and a power saving mode; and
a power source operatively associated with the controller and the RF generation module, the power source configured to receive a signal from the controller and transmit the signal to the RF generation module to cause the microwave oven to operate in normal operating mode or in power saving operating mode in accord with the signal, wherein the power source is a multi-tap transformer.

16. The microwave of claim 15, wherein the multi-tap transformer has two taps, a first tap engagable to maintain a power level of the RF generation module in the normal energy mode and a second tap engagable to reduce a power level of the RF generation module in the power saving mode.

17. The microwave oven of claim 15, wherein the multi-tap transformer has at least three taps configured to operate the microwave oven in varying degrees of power supply between and including normal operating mode and complete power saving operating mode.

18. The microwave of claim 15, wherein the controller is configured to block receipt of the energy signal when the RF generation module is activated.

19. The microwave oven of claim 18, wherein the controller is configured to queue the energy signal during activation of the RF generation module and process the queue after deactivation of the RF generation module for at least partially determining current operating mode for the microwave oven.

20. The microwave of claim 15, wherein the controller is configured to determine a frequency of the incoming energy signal, the controller temporarily blocking receipt of the energy signal when the RF generation module is activated if the determined frequency of the energy signal is impacted by a frequency of the RF generation module.
